(19) United States
(12) Patent Application Publication
(10) Pub. No.: US 2015/0245631 A1
(43) Pub. Date: Sep. 3, 2015

(54) S'more Cups - An Easier Way To Make S'mores

(71) Applicant: Joseph Ragain, Mountain House, CA (US)

(72) Inventor: Joseph Ragain, Mountain House, CA (US)

(21) Appl. No.: 14/683,146

(22) Filed: Apr. 10, 2015

(51) Int. Cl. A23G 1/50

(52) U.S. Cl. CPC A23G 1/507

(57) ABSTRACT

Making a traditional s'more requires balance, dexterity, and often multiple people. The present invention allows for a much easier creation of a s'more, by shaping the graham cracker and chocolate into a cup (or similar structure), with a hole in the bottom, so that the graham cracker and chocolate can rest over a dowel or other utensil, keeping it in place while the marshmallow is roasted. This new design dramatically increases the ease of creating a s'more.

### REFERENCES CITED

### U.S. Patent Documents

| | | |
|---|---|---|
| U.S. Pat. No. 6,296,884 | October 2001 | Okerlund |
| U.S. Pat. No. 1,732,322 | October 1929 | Wilson et al. |
| U.S. Pat. No. 6,616,957 | September 2003 | Wilhelm et al. |
| US 2011/0042382 | February 2011 | Vazzano |
| US 2014/0161944 | June 2014 | Briganti et al. |

### BACKGROUND

A s'more is very popular campfire treat, generally made by roasting a marshmallow, placing it onto a piece of chocolate, and sandwiching them between two pieces of graham cracker. Despite the popularity of the snack, the difficult process of creating a s'more has largely prevented the dessert from being enjoyed at any other time besides camping with multiple people.

The traditional process of creating a s'more includes placing a marshmallow onto a long skewer, dowel, or other utensil and roasting it over an open flame. Once the marshmallow is roasted, a person will hold a piece of graham cracker in their hand, put a piece of chocolate on top of the graham cracker and then somehow slide the marshmallow off of the skewer and onto the chocolate and graham cracker. The process is difficult because the marshmallow is typically very hot, so a person cannot simply use their hand to slide the marshmallow off of the skewer. Instead, a person will use another graham cracker to pin the marshmallow between the graham cracker and chocolate, creating a sandwich. The problem lies in a person needing one hand to hold the graham cracker and chocolate, one hand to hold the skewer that is holding the hot marshmallow, and yet another hand to hold the second piece of graham cracker as it's used to slide the marshmallow off of said skewer. Since most people don't have three hands, this requires the person to a.) request help from someone else, or b.) release the skewer, so that they can free up the other hand necessary to sandwich the marshmallow between two pieces of graham cracker and chocolate. If requesting help from someone else is not possible, a person may place the skewer holding the hot marshmallow under their armpit, between their knees, or somewhere else that may prove dangerous. Or they will have to let go of the skewer completely, placing it on a table, or a rock, or sticking the other end of into the sand, which may prove unsanitary. No other invention has ever addressed these problems in the way that my invention does.

By shaping the graham cracker into a cup (or similar structure), coating the inside of the graham cracker with chocolate and putting a hole in the bottom of the structure, it allows a person to create a s'more much more easily than ever before. In this fashion, when the s'more cup is placed over a dowel, it is held into place. A marshmallow can then be placed onto the top of the dowel and roasted to a person's liking with the use of only one hand. The person can then use their other hand to slide the graham cracker and chocolate cup back up the dowel, causing the roasted marshmallow to rest inside of the cup completing the s'more. Any individual with reasonable dexterity can now create a s'more without the need of another person's help, in a much safer and sanitary way than ever before.

### SUMMARY

The present invention provides a substantial improvement to the design and process involved in creating and consuming a s'more (A “S′more” is generally referring to, but not limited to, a graham cracker, chocolate and roasted marshmallow dessert.)

By lining the graham cracker with chocolate (either in one combined piece or two close-fitting pieces) and placing a small hole within the structure(s), it allows for the marshmallow roasting utensil to be placed through the hole of the graham cracker/chocolate structure, holding it in place while the marshmallow is roasted. Once the marshmallow is roasted to a person's liking, the graham cracker/chocolate structure is then simply slid up the roasting utensil where it will safely remove the marshmallow and complete the s'more.

### BRIEF DESCRIPTION OF THE DRAWINGS

FIG. 1 is a representation of a completed s'more cup.

FIG. 2 is an exploded view of the s'more cup's core components, including, from top-to-bottom, a marshmallow, chocolate (or other confection) lining, graham cracker cup and elongated dowel.

FIG. 3 is a side view of a graham cracker cup.

FIG. 4 is a top view of a graham cracker cup.

FIG. 5 is a side view of a chocolate or other confection lining.

FIG. 6 is a top view of a chocolate or other confection lining.

FIG. 7 is a representation of how a marshmallow should fit snugly into the graham cracker cup for best results.

FIG. 8 is a cross-sectional view cut along the axis 8-8 referenced in FIG. 7.

FIG. 9 is a top-angled view of a square-shaped graham cracker and chocolate (or other confection) cup.

FIG. 10 is a top view of a square-shaped graham cracker cup.

FIG. 11 is a side view of a square-shaped graham cracker cup.

FIG. 12 is a step-by-step example of how someone would use a s'more cup to make a s'more.

FIG. 13 is a text representation of the process shown in FIG. 12.

### DETAILED DESCRIPTION OF THE INVENTION AND PREFERRED PROCESS

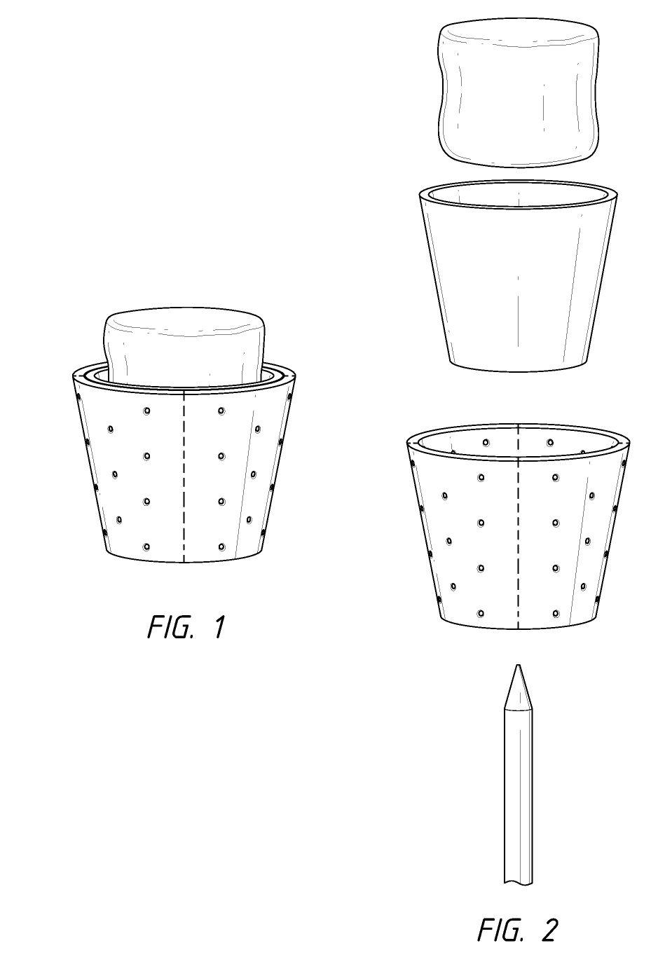

Referring to FIG. 1, the optimal, albeit not required, result is a roasted marshmallow resting snugly inside of the s'more cup, melting the chocolate (or other confection) on all sides.

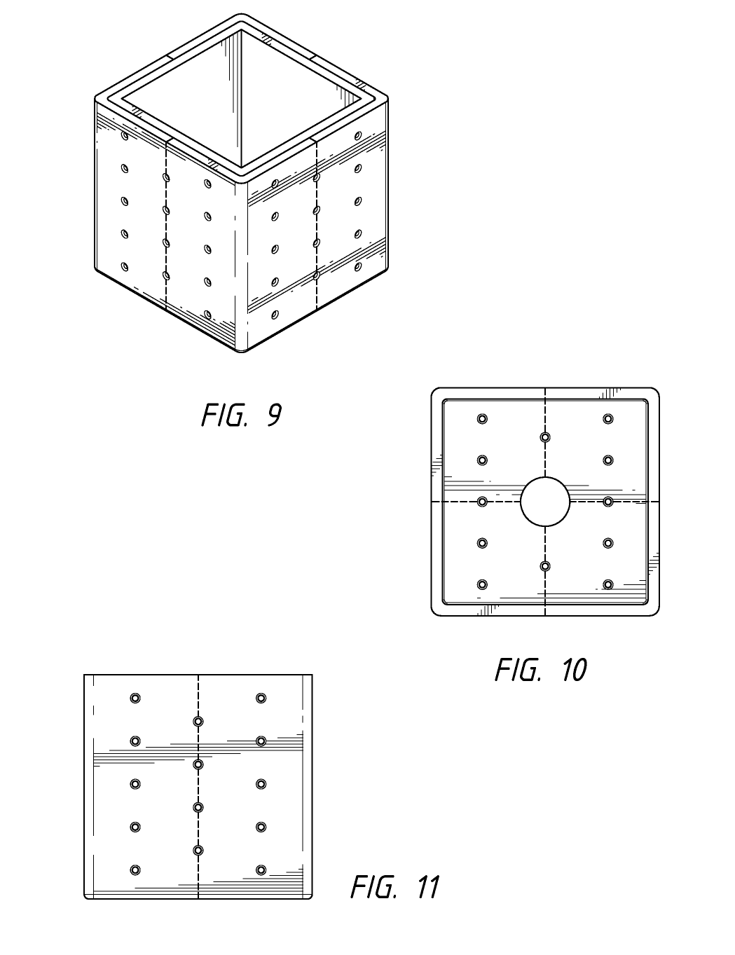

Referring to FIG. 1, the roasted marshmallow may protrude from the top of the s'more cup at various lengths, or not at all. Referring to FIG. 1 and FIG. 9, the graham cracker cup may come in a variety of shapes, sizes, heights, widths, textures, flavors, and wall angles. The wall angle can be anywhere from 90 to 180 degrees with the optimal angle typically falling between 90-110 degrees. A wall angle less than 90 degrees is possible, but not ideal, as a roasted marshmallow would have difficulty touching all sides of the s'more cup.

Referring to FIG. 2, the four primary components of a s'more cup include a marshmallow, chocolate lining, a graham cracker cup, and a dowel. However, a multitude of different varieties can be used with similar success. The marshmallow may come in different flavors, like strawberry, mint, chocolate, coffee, banana, or others. The chocolate lining may be replaced with vanilla, caramel, chocolate mint, strawberry, coffee, or others. The graham cracker cup may come in different flavors like honey, cinnamon, chocolate, or others. The roasting utensil used to hold the s'more cup in place and roast the marshmallow can be a variety of materials and lengths, typically falling somewhere between 6 and 36 inches, depending upon safety and the source of the flame used to roast the marshmallow.

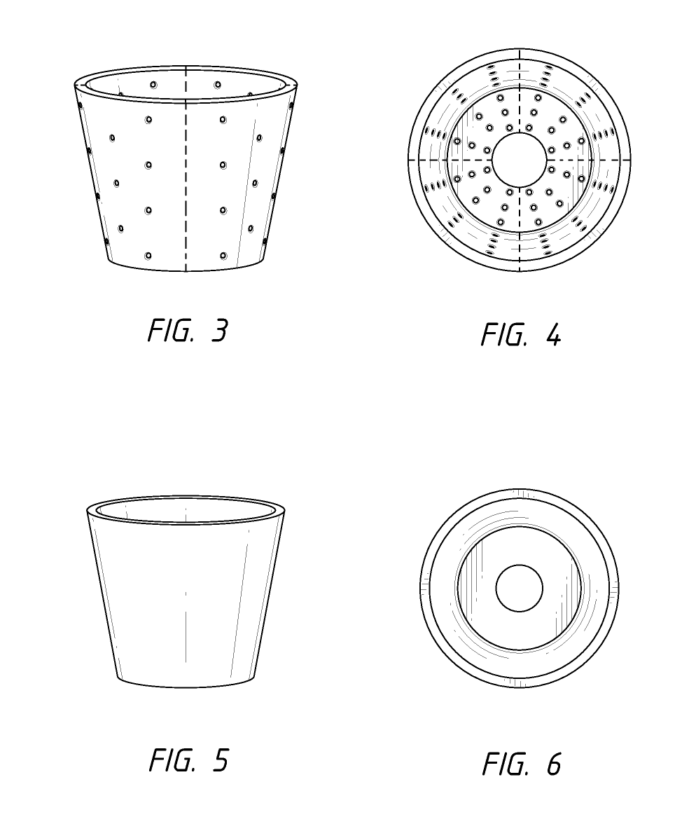

FIG. 3 represents the optimal shape of a s'more cup, which resembles a standard 1½ ounce “shot” glass used for drinking liquor. A s'more cup of this size and shape will allow most for most brands of “jumbo-sized” marshmallows to fit perfectly inside, if the s'more cup is to be used with a marshmallow not purchased with s'more cup itself. The s'more cup may also come in much smaller sizes, to fit a “miniature-sized” marshmallows, or much larger, to fit even larger marshmallows.

Referring to FIG. 4, the most critical feature of the s'more cup is the hole that allows for the roasting utensil to hold the s'more cup in place while the marshmallow is roasted. The hole can come in a variety of different shapes and sizes, so long as the roasting utensil can be slid safely through the s'more cup without breaking it. It is technically possible to use the roasting utensil or another sharp object to puncture the bottom of an enclosed-bottomed s'more cup to create the hole with similar effect, but one would run the risk of breaking the s'more cup and stopping the ability to make the s'more cup correctly. The ideal design is for the hole to be present at all times.

Referring to FIG. 4, small holes for aeration and even cooking may or may not be present in the graham cracker cup's design.

Referring to FIG. 5, the chocolate (or other confection) will line the graham cracker cup's general size and shape. The chocolate may extend over the lip of the cup, or even start somewhere down the wall of the cup, but for optimal results it will line the inside of the cup in its entirety.

Referring to FIG. 6, the chocolate lining (or other confection) will also require a hole, or the ability to easily make a hole, for the roasting utensil to go through.

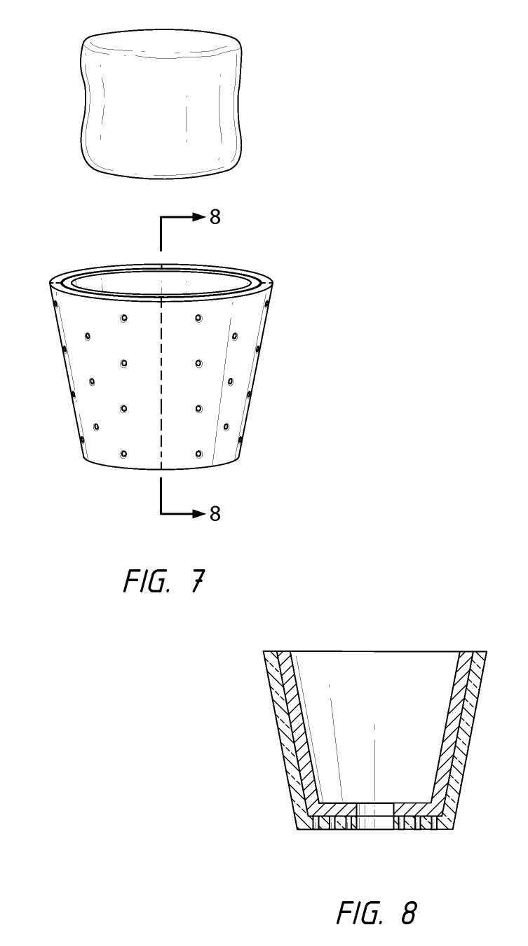

Referring to FIG. 8, ratio of graham cracker to chocolate (or other confection) can, but doesn't need to be 1:1. A “double-chocolate” option may prove popular, where the ratio of chocolate to graham cracker can be 2:1 or even higher. A “chocolate-light” version may have a chocolate to graham cracker ratio of 1:2 or even lower.

Referring to FIG. 9, FIG. 10, and FIG. 11, a variety of shapes and or sizes can be used to achieve the same results, as long as the four main components (marshmallow, chocolate or other confection, graham cracker cup, and roasting utensil) are present.

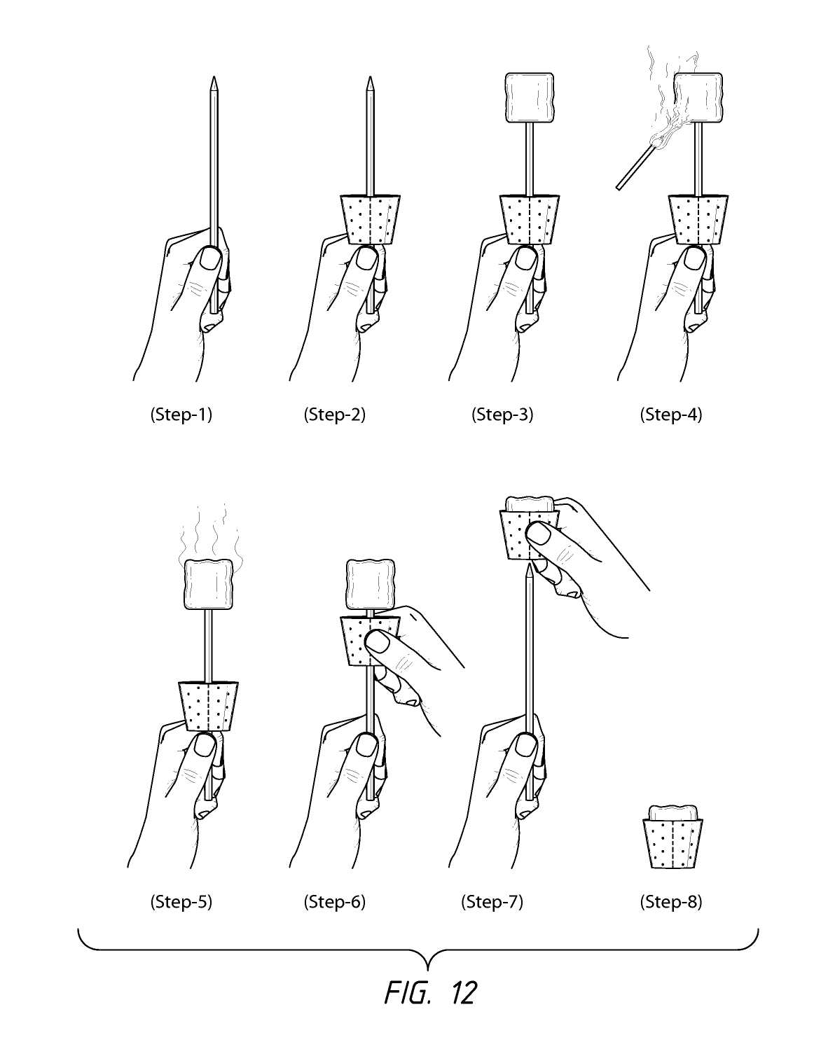

Referring to FIG. 12, this is a step-by-step visual representation of a person using a s'more cup. The steps listed below are an optimal way of using a s'more cup, but not the only way.

Step 1: Grab Dowel.

Step 2: Slide Graham Cracker Cup over Dowel through the Hole in the Bottom. Rest on Hand.

Step 3: Put Marshmallow on Dowel.

Step 4: Roast Marshmallow to Liking (match and flame).

Step 5: Extinguish any Flames

Step 6: Use other Hand to Slide Graham Cracker Cup back up the Dowel.

Step 7: Pull Dowel through Hole in the Bottom of the Graham Cracker Cup.

Step 8: Roasted Marshmallow will Settle Inside Chocolate Lined Graham Cracker Cup and Ready to Eat.

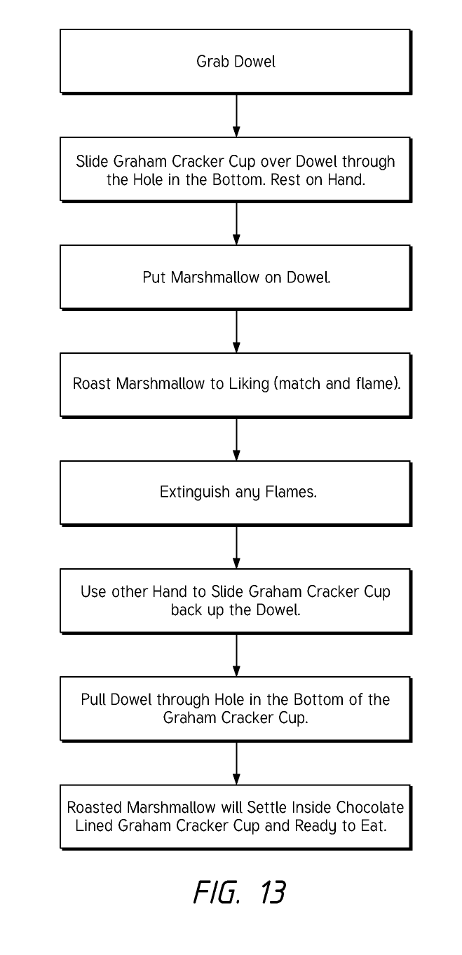

Referring to FIG. 13, this is a step-by-step text representation of the above optimal way of using a s'more cup.

I claim:

1. A method of making a s'more, comprising:
(a) a confection lined wafer
(b) a hole in said wafer for a dowel to be placed through as a means of holding said wafer in place while a marshmallow is roasted.
